(19) United States
(12) Patent Application Publication
(10) Pub. No.: US 2023/0244768 A1
(43) Pub. Date: Aug. 3, 2023

(54) SYSTEMS AND METHODS FOR INTENT-BASED DEVICE UNLOCKING

(71) Applicant: Matthew Edward Natividad Healey, Spanish Fork, UT (US)

(72) Inventor: Matthew Edward Natividad Healey, Spanish Fork, UT (US)

(21) Appl. No.: 17/590,307

(22) Filed: Feb. 1, 2022

(51) Int. Cl. G06F 21/32; G06V 40/16; G06V 20/40

(52) U.S. Cl. CPC G06F 21/32; G06V 40/171; G06V 40/172; G06V 40/165; G06V 20/46

(57) ABSTRACT

A system for facilitating intent-based device unlocking is configurable to detect a set of facial features using one or more sensors of a user device and bind the set of facial features with a particular application of a plurality of applications of the user device. Binding the set of facial features with the particular application causes the particular application to be surfaced for display on the user device upon unlocking of the user device when the set of facial features is detected during an unlock signal detection process of the user device.

### BACKGROUND

Mobile electronic devices have become ubiquitous in developed (and developing) societies. For example, many individuals carry smartphones, tablets, laptops, head-mounted displays (HMDs), other wearable devices (e.g., smartwatches), and/or others. Such devices typically include various software applications that are usable for various purposes. For example, a user device may include a map or navigation application, a calendar application, a web browser, a calculator, a word processing application (e.g., for accessing documents or writing notes), and/or others.

Some applications utilize or provide access to sensitive and/or private information. For example, a mobile electronic device may include applications that store or utilize payment information (e.g., credit card information) to facilitate financial transactions (e.g., near-field communication (NFC) transactions). Other private information may include personal photographs/videos, private notes/communications, and/or others.

Accordingly, many electronic devices include locking functionality to improve device security. For example, when an electronic device is in a locked state, access to at least some of the applications and/or functionalities of the electronic device may be restricted until an authentication process is successfully completed. Electronic devices may enter into a locked state in various ways, such as after a predetermined time period has elapsed without user interaction (e.g., 30 seconds, 1 minute, 3 minutes, 5 minutes, etc.), in response to user input (e.g., pressing a device lock/unlock button or providing a device lock command), in response to sensor input (e.g., sensors detecting that a device is in a folded/closed configured), and/or others.

As noted above, when an electronic device is in a locked state, access to the applications and/or functionalities of the electronic device may become available upon successful completion of the authentication process (e.g., rendering the device “unlocked”). Some authentication processes (e.g., “unlocking” processes) include password entry, pin code entry, fingerprint recognition, facial recognition, iris recognition, etc.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates example components of an example system that may include or be used to implement one or more disclosed embodiments;

FIGS. 2A and 2B illustrate conceptual representations of a user device capturing facial features of a user;

FIG. 3 illustrates a conceptual representation of binding a set of facial features to an application of a user device;

FIGS. 4A through 4C illustrate a conceptual representation of detecting a set of facial features during an unlock signal detection process of a user device;

FIGS. 5 and 6 illustrate conceptual representations of binding different sets of facial features to different applications of a user device;

FIGS. 7A and 7B illustrate a conceptual representation of detecting a set of facial features during an unlock signal detection process of a user device; and

FIGS. 8 and 9 illustrate flow diagrams depicting acts associated with facilitating intent-based device unlocking.

### DETAILED DESCRIPTION

Disclosed embodiments are generally directed to systems, methods, and devices that facilitate intent-based device unlocking.

As noted above, many electronic devices are configured to enter a locked state responsive to certain input or after a certain period of inactivity. Devices typically remain in a locked state until an authentication or unlocking process is successfully completed/performed (e.g., password entry, detection of biometric features/signatures, etc.).

Upon becoming unlocked responsive to completion of an authentication/unlocking process, a device typically displays (i) the content that was displayed when the device previously entered the locked state or (ii) a predefined “home screen” or landing content. However, displaying such content responsive to a device becoming unlocked can present an obstacle to efficient use of the device.

For example, during a time period in which a user's mobile electronic device is in a locked state (e.g., residing in a user's pocket), the user may recognize or realize a need to access certain content on their mobile electronic device. In many instances, the content that the user needs to access is different than (i) the content that was displayed when the device previously entered the locked state and (ii) the home screen of the device. Accordingly, upon unlocking of the device, the user may need to navigate away from the content displayed upon unlocking of the device to reach the desired content that initially motivated the user's performance of the device unlock process.

The intermediate navigation described above for reaching desired content upon unlocking of a device reduces the efficiency of the user's operation of the device and can, in some instances, prevent the user from reaching the desired content altogether. By way of illustrative example, through the normal course of real-world interactions, a user may realize a need to access a messaging application (e.g., a short messaging service (SMS) and/or multimedia messaging service (MMS) application) on their smartphone (or other electronic device(s)) to send a particular message to a particular person. The user thus removes their smartphone from their pocket and unlocks the smartphone (e.g., by facial recognition). However, upon unlocking of the smartphone, the user is presented with a social media feed (e.g., the content that was displayed when the smartphone was previously locked and placed in the user's pocket). The user may become distracted by and begin to consume the content presented on the social media feed. After a time, the user may decide to cease consuming/scrolling through the content of the social feed and may lock the electronic device add return it to the user's pocket, without ever fulfilling the purpose for which the electronic device was unlocked in the first place (i.e., to access the messaging application to send the particular message to the particular person).

Accordingly, there exists a substantial need for improved techniques for facilitating efficient use of electronic devices, such as by enabling users to quickly and efficiently navigate directly to desired content upon unlocking of electronic devices. For example, disclosed embodiments are directed to systems, methods, devices, and/or techniques for associating or binding a set of facial features to a particular application of a user device. The association or binding may cause the particular application to be surfaced for display/interaction on the user device when the set of facial features bound to the application is detected during an unlocking or authentication process of the user device. Such functionality may allow users to rapidly and efficiently access desired applications directly following completion of a device unlocking process, rather than requiring users to navigate from previous content to desired content upon unlocking of the device.

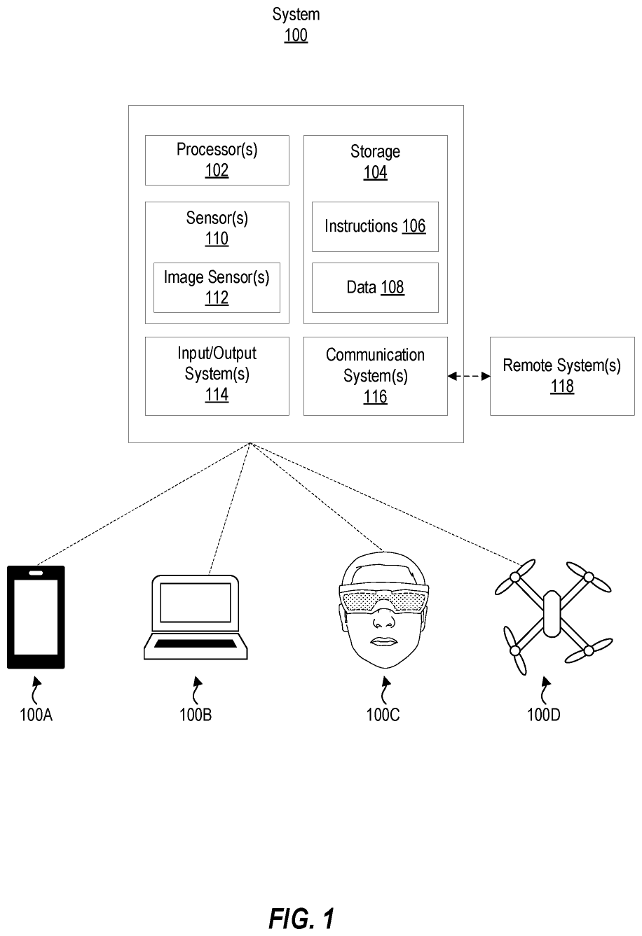

Having just described some of the various high-level features and benefits of the disclosed embodiments, attention will now be directed to FIGS. 1 through 9. These Figures illustrate various conceptual representations, architectures, methods, and supporting illustrations related to the disclosed embodiments.

### Example Systems and Techniques for Facilitating Intent-Based Device Unlocking

FIG. 1 illustrates various example components of a system 100 that may be used to implement one or more disclosed embodiments. For example, FIG. 1 illustrates that a system 100 may include processor(s) 102, storage 104, sensor(s) 110, image sensor(s) 112, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions 106 stored within storage 104 to perform certain actions. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 118 may comprise any combination of software or hardware components that are operable to facilitate communication between on-system components/devices and/or with off-system components/devices. For example, the communications system(s) 118 may comprise ports, buses, or other physical connection apparatuses for communicating with other devices/components. Additionally, or alternatively, the communications system(s) 118 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomenon. By way of non-limiting example, the sensor(s) 110 may comprise one or more image sensor(s) 112 (e.g., CMOS, CCD, SPAD, and/or others), depth sensors (e.g., stereo cameras, time of flight cameras, etc.), microphones, thermometers, barometers, magnetometers, accelerometers, gyroscopes, inertial measurement units (IMUs) and/or others. The image sensor(s) 112 may be configured to capture images of a user to facilitate authentication and/or unlocking (e.g., images of facial features/landmarks, images of iris features/landmarks, etc.).

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, and/or others, without limitation. For example, the I/O system(s) 114 may include a display system that may comprise any number of display panels, optics, laser scanning display assemblies, and/or other components.

FIG. 1 conceptually represents that the components of the system 100 may comprise or utilize various types of devices, such as mobile electronic device 100A (e.g., a smartphone), personal computing device 100B (e.g., a laptop), a mixed-reality head-mounted display 100C (HMD 100C), an aerial vehicle 100D (e.g., a drone), and/or other devices. Although the present description focuses, in at least some respects, on utilizing an HMD to implement techniques of the present disclosure, additional or alternative types of systems may be used.

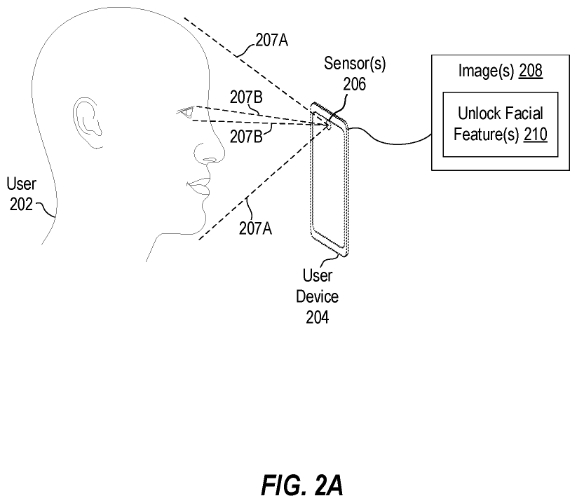

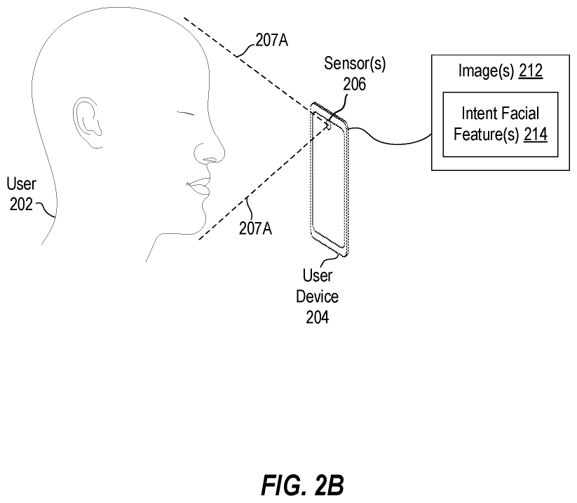

FIGS. 2A and 2B illustrate conceptual representations of a user device capturing facial features of a user. In particular, FIG. 2A illustrates a user 202 and a user device 204. The user device 204 may comprise an implementation of a system 100 as described hereinabove and may comprise one or more components of a system 100 discussed hereinabove. For instance, FIG. 2A illustrates the user device 204 as including sensor(s) 206, which may correspond to image sensor(s) 112 and/or depth detection systems (e.g., stereo cameras and/or a time of flight system that includes a detector in combination with one or more illuminators).

As illustrated in FIG. 2A, the user device 204 may capture image(s) 208 of the user 202 via the sensor(s) 206. The sensor(s) 206 may capture the face of the user 202 such that the image(s) 208 include facial features of the user 202 (as indicated by the field of view 207A shown in FIG. 2A). The facial features may include facial landmarks and/or nodal points of a human face, such as inter-eye distance, nose width, eye socket depth, distance from forehead to chin, and/or others. Any suitable facial landmark recognition configuration may be utilized in accordance with the present disclosure, such as, by way of non-limiting example, MULTI-PIE, MUCT, XM2VTS, MENPO, AFLW, PUT, Caltech 10 k, BioID, HELEN, Face ID, and/or others.

As will be described in more detail hereinafter, the facial features represented in the image(s) 208 may be stored and utilized to facilitate unlocking of the user device 204. The facial features represented in the image(s) 208 are therefore labeled as “unlock facial feature(s) 210” in FIG. 2A. For instance, the unlock facial feature(s) 210 may be utilized as and/or to generate a unique facial signature (e.g., a face code or a face print) of the user 202, which may comprise a mathematical model of the face of the user 202. When the unique facial signature is subsequently detected during an unlocking process of the user device 204 (e.g., within a suitable margin of error), the device may transition from a locked state to an unlocked state (as described above).

In some instances, the unlock facial feature(s) 210 may additionally or alternatively utilize or rely on iris scanning techniques. For instance, the image(s) 208 may capture one or more irises of the user 202 (as indicated in FIG. 2A by the field of view 207B), and iris features and/or patterns may be identified and/or used to generate one or more iris signatures (e.g., iris codes or iris patterns). The iris signature(s) may be subsequently utilized to facilitate unlocking of the user device 204. Any suitable iris recognition framework may be implemented in accordance with the present disclosure.

To facilitate device unlock functionality that is driven by user intent, the user device 204 may capture one or more additional facial features that may be bound to one or more particular applications of the user device 204, such that when such additional facial feature(s) are subsequently detected during a device unlock process of the user device 204, the particular application(s) may be automatically navigated to and/or displayed directly upon unlocking of the user device 204.

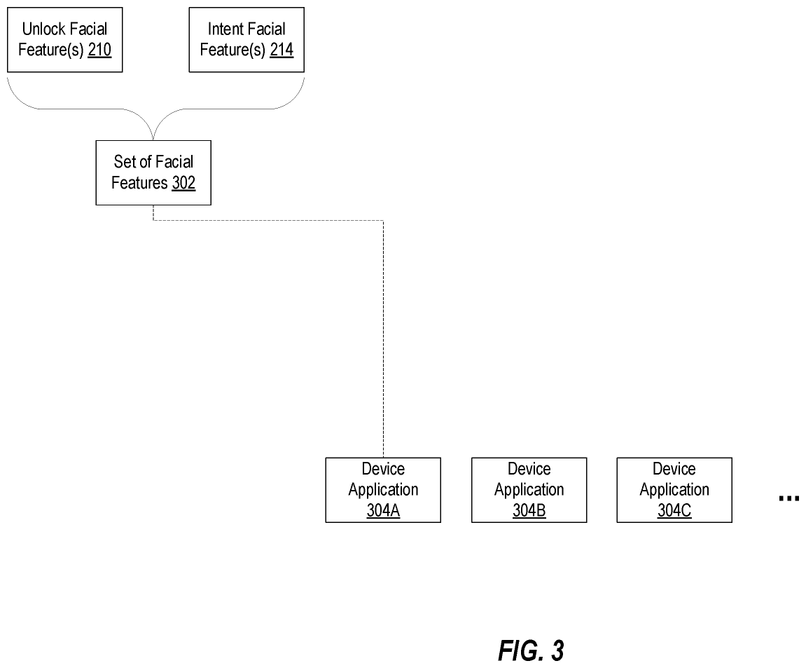

FIG. 2B accordingly illustrates the user 202 with a different facial configuration than the neutral facial configuration of the user 202 as shown in FIG. 2A. In the example of FIG. 2B, the user 202 has their right eye closed. FIG. 2B illustrates the sensor(s) 206 capturing image(s) 212 of the user 202 under such a facial configuration (as indicated in FIG. 2B by the field of view 207A). Aspects of this facial configuration may be stored as intent facial feature(s) 214 and may be associated with an application of the user device 204 (see FIG. 3) such that subsequent detection of the intent facial feature(s) 214 during an unlock process of the user device 204 (e.g., within a suitable margin of error) causes the application to be surfaced upon unlocking of the user device 204. Any facial configuration may be utilized to indicate a user's intended application in accordance with the present disclosure, such as closing one or both eyes, raising or furrowing one or both eyebrows, smiling, frowning, and/or others.

The intent facial feature(s) 214 may be represented by the same type of data as the unlock facial feature(s) 210 and/or by a different type of data than the unlock facial feature(s) 210. For instance, the intent facial feature(s) 214 may be represented by one or more facial or iris signatures as discussed above (with reference to the unlock facial feature(s) 210) and/or utilizing face tracking signals that measure the relative or absolute positioning and/or motion of one or more facial structures (e.g., the eyebrows, eyelids, outer/inner cheeks, nose, mouth, chin, and/or other facial structure of the user 202). In some instances, face tracking signals are less secure and/or unique relative to facial signatures or iris signatures. In some implementations, where the intent facial feature(s) 214 are represented using face tracking signals and the unlock facial feature(s) 210 are represented using facial signatures or iris signatures, the intent facial feature(s) 214 may be regarded as unsecure facial features, whereas the unlock facial feature(s) 210 may be regarded as secure facial features. Notwithstanding their unsuitableness for security authentication, face tracking signals may be suitable for indicating user intent sufficient to trigger surfacing of a desired application of the user device 204, as will be described in more detail hereinbelow.

The unlock facial feature(s) 210 and the intent facial feature(s) 214 may be obtained by a user device 204 (and/or other system) in various ways, such as by providing one or more user prompts on a display of the user device 204 to cause the user to assume one or more predefined or user-defined facial configurations (e.g., neutral/resting facial configuration with open eyes, closing one eye, etc.) and capturing image(s) and/or video of the user's face (e.g., pursuant to a calibration or onboarding process).

As illustrated in FIG. 3, the unlock facial feature(s) 210 and the intent facial feature(s) 214 may comprise a set of facial features 302, which may be bound to or associated with a particular device application 304A of the user device 204 (as indicated in FIG. 3 by the dashed line extending from the set of facial features 302 to the device application 304A). The device application 304A may comprise one of a plurality of device applications of the user device 204 (as indicated in FIG. 3 by device applications 304B and 304C and the ellipsis). The binding of the set of facial features 302 to the device application 304A may cause the device application 304A to be automatically surfaced for display on the user device 204 when the set of facial features 302 is detected pursuant to an unlock signal detection process of the user device 204 (e.g., detecting image/video frames with the sensor(s) 206 of the user device 204 and analyzing the image/video frames to detect the presence of the unlock facial feature(s) 210 and/or accompanying intent facial feature(s) 214). In response to detecting the set of facial features 302 pursuant to the unlock signal detection process, the device application 304A may become displayed on the user device 204 even when a different device application was previously displayed on the user device 204 when the user device 204 previously entered the locked state prior to the unlock signal detection process.

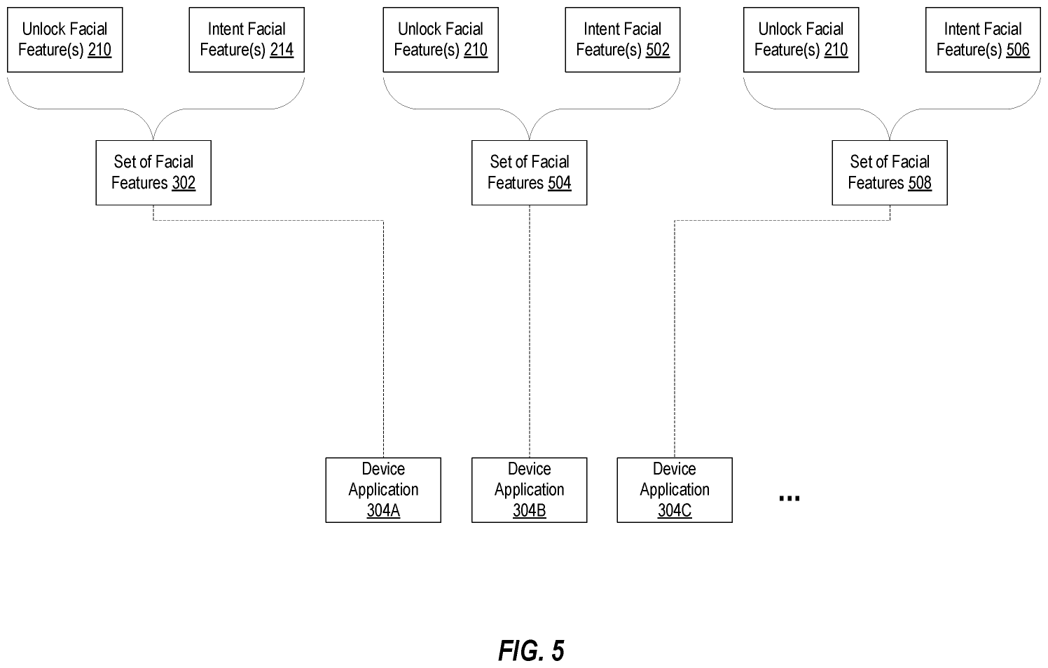

The binding of the set of facial features 302 to the device application 304A may be effectuated in any suitable manner, such as by generating and/or storing computer-readable instructions that cause the user device 204 to automatically navigate to or open the device application 304A in response to detection of the intent facial feature(s) 214 during the unlocking process or unlocking of the user device 204 (e.g., in combination with detecting the unlock facial feature(s) 210 to trigger the unlocking of the user device 204). Although FIG. 3 conceptually depicts the set of facial features 302 as bound to the device application 304A, one will appreciate, in view of the present disclosure, that the intent facial feature(s) 214 may be individually regarded as bound to the device application 304A without the unlock facial feature(s) 210 being necessarily regarded as bound to the device application 304A. For instance, the unlock facial feature(s) 210 may be utilized independently of the intent facial feature(s) 214 to unlock the user device 204 under conventional approaches (e.g., to surface the content previously displayed on the user device 204), and/or the unlock facial feature(s) 210 may be utilized in combination with different intent facial feature(s) as a separate set of facial features for causing display of a different device application upon unlocking of the user device 204 (see FIG. 5).

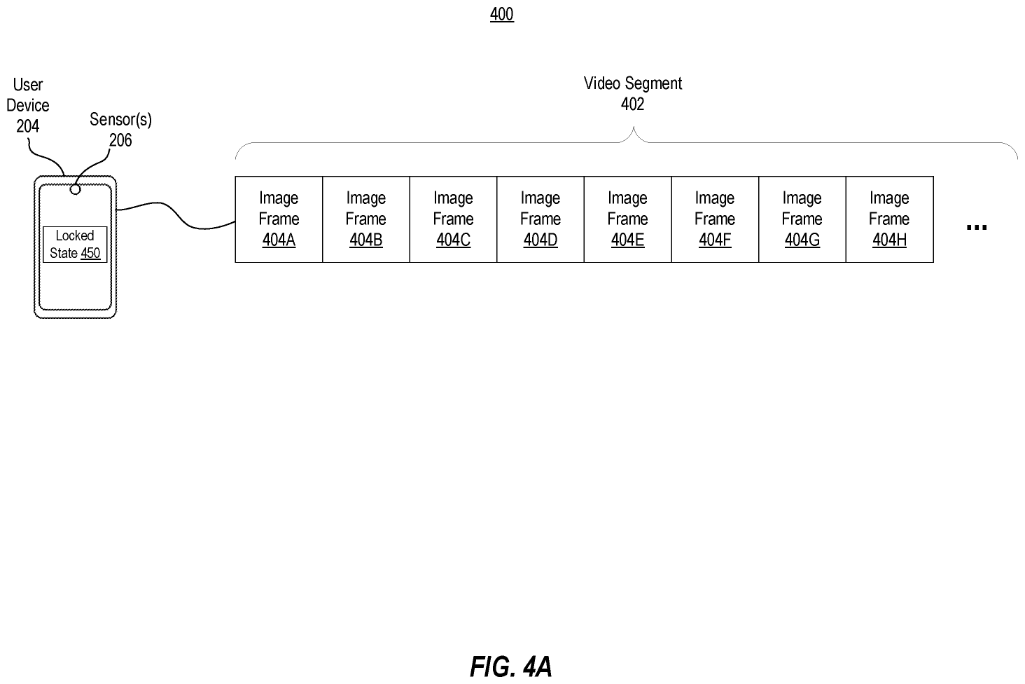

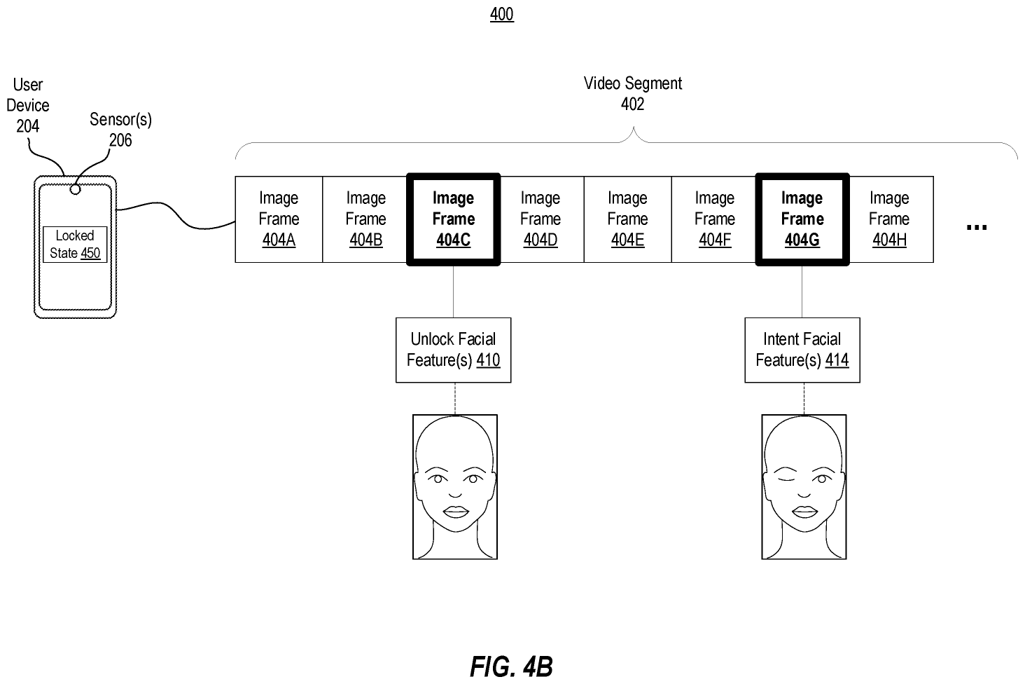

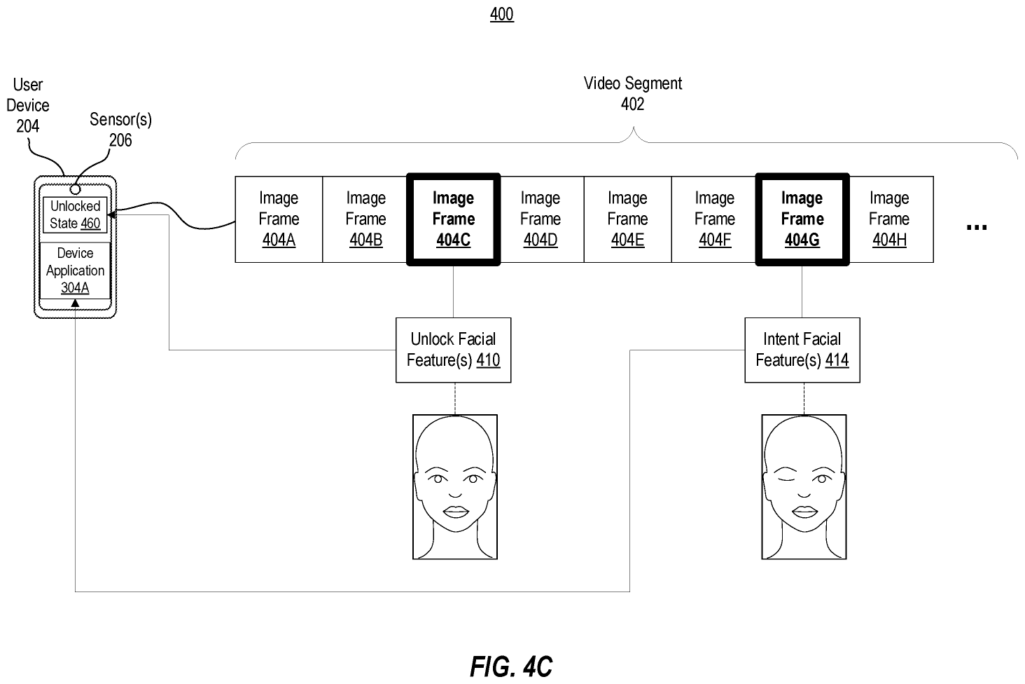

FIGS. 4A through 4C illustrate a conceptual representation of an unlock signal detection process 400 of the user device 204, which may be used to facilitate intent-based unlocking of the user device 204. An unlock signal detection process 400 may include attempting to detect (i) a signature or key signal (e.g., unlock facial feature(s) 210) that will allow the user device 204 to transition from a locked state to an unlocked state and (ii) an indication of user intent (e.g., intent facial feature(s) 214) that can cause the user device 204 to automatically navigate to and/or display content in accordance with the user's intent (e.g., based on the indication of user intent being bound to a particular application of the user device 204, as shown in FIG. 3).

In the example of FIG. 4A, the unlock signal detection process 400 includes capturing a set of images using the sensor(s) 206 of the user device 204. Such image capturing may occur while the user device 204 is in a locked state 450. The captured images may form image frames of a video segment 402 (e.g., image frames 404A through 404H, etc., of video segment 402, as shown in FIG. 4A). Each of the image frames 404A through 404H may represent a set of one or more image frames of the video segment 402.

The image frames of the video segment 402 may be analyzed to determine whether facial features corresponding to stored unlock facial features and/or intent facial features are present in the captured image frames 404A through 404H of the video segment 402. In some instances, a higher threshold of similarity or matching is required to determine that unlock facial features are present in the image frames of the video segment 402 than a threshold of similarity or matching that is required to determine that intent facial features are present in the image frames of the video segment 402. A lower or smaller margin of error may be implemented to determine that detected facial features sufficiently correspond stored unlock facial feature(s) than a margin of error implemented to determine that detected facial features sufficiently correspond to stored intent facial feature(s).

The image frames of the video segment 402 may be analyzed in any suitable manner (e.g., utilizing MULTI-PIE, MUCT, XM2VTS, MENPO, AFLW, PUT, Caltech 10 k, BioID, HELEN, Face ID, and/or others) to detect presence of facial features corresponding to stored unlock facial features and/or intent facial features. For instance, the image frames 404A through 404H may be sequentially analyzed (individually or in batches) to detect presence of unlock facial features. In response to detecting acceptable unlock facial features in an image frame, the remaining image frames may be analyzed to detect presence of intent facial features. The remaining image frames that are analyzed for intent facial features may be regarded as a second subset of image frames of the video segment 402, whereas the preceding image frames that were analyzed for the unlock facial features may be regarded as a first subset of image frames of the video segment 402. The second subset of image frames is temporally subsequent to the first subset of image frames (e.g., temporally subsequent to the image frame in which acceptable unlock facial features are detected).

In some instances, the image frames of the video segment (or batches of image frames of the video segment) are analyzed non-sequentially (e.g., in parallel) to detect the presence of the unlock facial features and/or the intent facial features (e.g., regardless of order). Other analysis methodologies for detecting unlock facial features and/or intent facial features within imagery captured by a user device are within the scope of the present disclosure.

FIG. 4B illustrates a continuation of the unlock signal detection process 400 initiated in FIG. 4A, wherein the image frames of the video segment 402 are analyzed to detect facial features that correspond to stored unlock facial features and/or stored intent facial features (e.g., unlock facial features 210 and intent facial features of FIGS. 2A and 2B, respectively). FIG. 4B illustrates image frame 404C as depicting unlock facial feature(s) 410 of the user 202 that correspond (within a suitable margin of error) to the stored unlock facial feature(s) 210 discussed above with reference to FIG. 2A. For instance, FIG. 4B depicts that the unlock facial feature(s) 410 capture a facial signature of the user 202 under a neutral facial configuration, similar to the facial configuration of the user 202 that existed during acquisition of the image(s) 208 capturing the unlock facial feature(s) 210 of FIG. 2A. FIG. 4B furthermore illustrates image frame 404G as depicting intent facial feature(s) 414 that correspond (within a suitable margin of error) to the stored intent facial feature(s) 214 discussed hereinabove with reference to FIG. 2B. For instance, FIG. 4B depicts that the intent facial feature(s) 414 capture face tracking signals of the user 202 with the user's right eye closed, similar to the facial configuration of the user 202 that existed during acquisition of the image(s) 212 capturing the intent facial feature(s) 214 of FIG. 2B. As noted above, the unlock facial feature(s) 410 and the intent facial feature(s) 414 may be detected according to any suitable detection methodology.

In response to detecting the unlock facial feature(s) 410 and the intent facial feature(s) 414 (e.g., the set of facial features 302) in the video segment 402 captured pursuant to the unlock signal detection process 400, the user device 204 may transition from the locked state 450 to an unlocked state 460, as indicated in FIG. 4C by the arrow extending from the unlock facial feature(s) 410 to the unlocked state 460. The user device 204 may furthermore automatically surface a device application that is bound to the intent facial feature(s) 414 detected in the video segment 402. As noted above, the intent facial feature(s) 414 correspond to the intent facial feature(s) 214 that are bound to device application 304A. Accordingly, FIG. 4C shows that the detection of the intent facial feature(s) 414 within the video segment 402 may cause the user device 204 to automatically surface device application 304A upon transitioning to the unlocked state 460 (as indicated in FIG. 4C by the arrow extending from the intent facial feature(s) 414 to the device application 304A on the user device 204).

Device application 304A may be surfaced even if device application 304A was not previously displayed on the user device 204 when the user device 204 initially entered the locked state 450. Such functionality may enable users to rapidly access desired content upon unlocking of their devices, thereby improving user efficiency and reducing the possibility of the user becoming distracted by intervening content while attempting to navigate to desired content.

Different sets of facial features may be associated with different device applications to allow users to rapidly navigate to different device applications upon unlocking of their device. By way of non-limiting example, one set of intent facial features (e.g., a user closing their left eye) maybe bound to a word processing application, whereas another set of facial features (e.g., a user closing their right eye) may be bound to a navigation/map application, while yet another set of facial features (e.g., a user raising their eyebrows) may be bound to a messaging application, etc. FIG. 5 illustrates an example in which, in addition to the set of facial features 302 bound to the device application 304A as discussed above, a set of facial features 504 is bound to device application 304B, and another set of facial features 508 is bound to device application 304C.

In the example of FIG. 5, the different sets of facial features 302, 504, and 508 are associated with respective intent facial features (intent facial feature(s) 214 for the set of facial features 302, intent facial feature(s) 502 for the set of facial features 504, and intent facial feature(s) 506 for the set of facial features 508) and with the same unlock facial feature(s) 210. In other examples, one or more of the different sets of facial features are associated with different unlock facial features. Furthermore, in other examples, facial features may operate to both unlock a device and indicate user intent regarding which application to surface upon unlocking of the device.

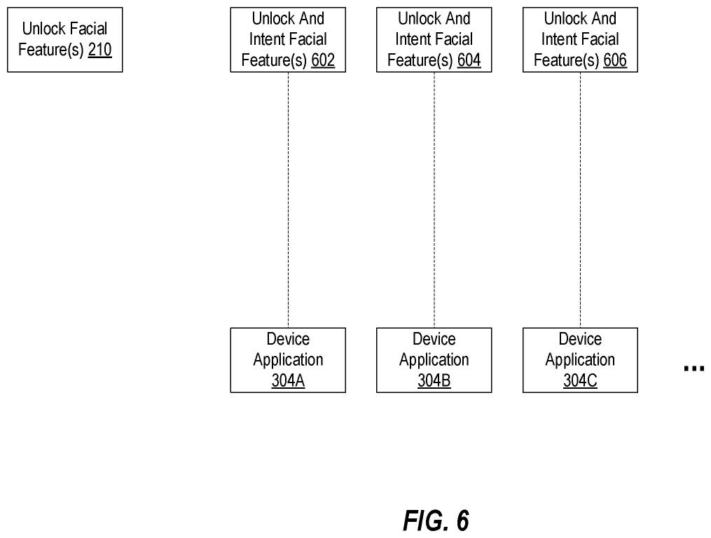

For instance, FIG. 6 illustrates the unlock facial feature(s) 210, which may be utilized independent of user intent indicia to unlock the user device 204 under conventional techniques (e.g., to surface previously displayed content upon device unlocking, or to return the user to a home screen upon unlocking). FIG. 6 also illustrates different unlock and intent facial feature(s) 602, 604, and 606 bound to the different device applications 304A, 304B, and 304C, respectively. The different unlock and intent facial feature(s) 602, 604, and 606 may each comprise individual facial configurations and/or gestures that may be bound to particular device applications such that detection of the unlock and intent facial feature(s) 602, 604, and 606 during a device unlocking process may cause the corresponding device application to become surfaced for display upon unlocking of the device (e.g., rather than utilizing a set of facial features that includes a combination of both unlock facial feature(s) and separate intent facial feature(s) to facilitate intent-driven device unlocking).

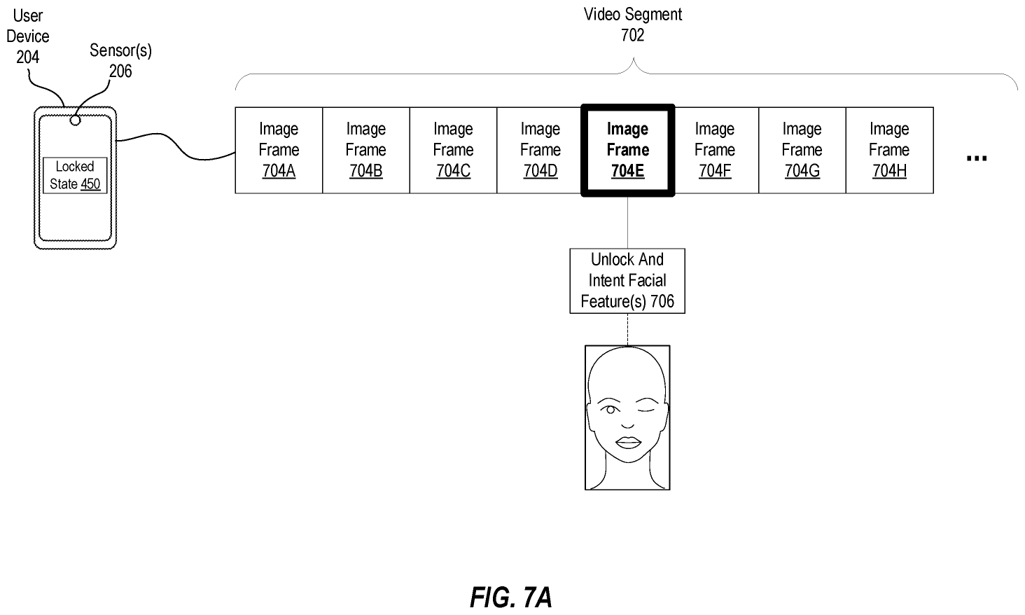

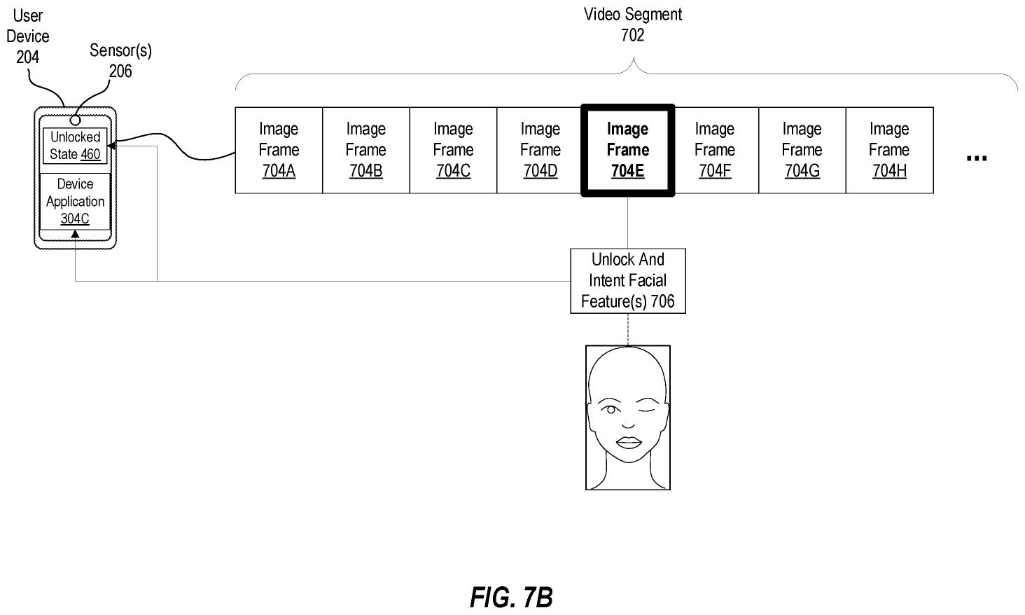

Continuing with the above example, FIG. 7A illustrates the user device 204 in the locked state 450 and a video segment 702 captured via the sensor(s) 206 of the user device 204. The image frames 704A through 704H (each of which may represent one or more image frames) of the video segment 702 may be analyzed to determine whether facial features corresponding to the unlock facial features(s) 210 or any of the unlock and intent facial feature(s) 602, 604, or 606 are present within the image frames 704A through 704H. In the example of FIG. 7A, image frame 704E includes unlock and intent facial feature(s) 706 corresponding to unlock and intent facial feature(s) 606 that are bound to device application 304C as illustrated in FIG. 6. Consequently, the detection of the unlock and intent facial feature(s) 706 may cause the user device 204 to transition into the unlocked state 460 and automatically surface the device application 304C (as indicated in FIG. 7B by the arrows extending from the unlock and intent facial feature(s) 706 to the unlocked state 460 and the device application 304C of the user device 204).

Although the present examples focus, in at least some respects, on utilizing facial features to facilitate unlocking and/or intent-driven automated navigation to particular content upon unlocking of a user device, other types of inputs may be utilized to facilitate such functionality, such as fingerprints, body gestures, device motion, and/or others.

### Example Method(s) for Facilitating Intent-Based Device Unlocking

The following discussion now refers to a number of methods and method acts that may be performed by the disclosed systems. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

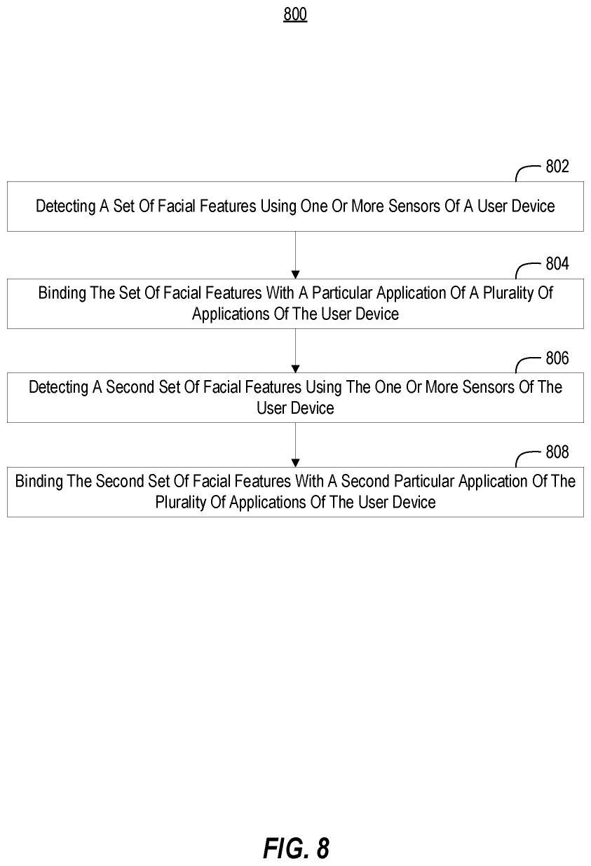

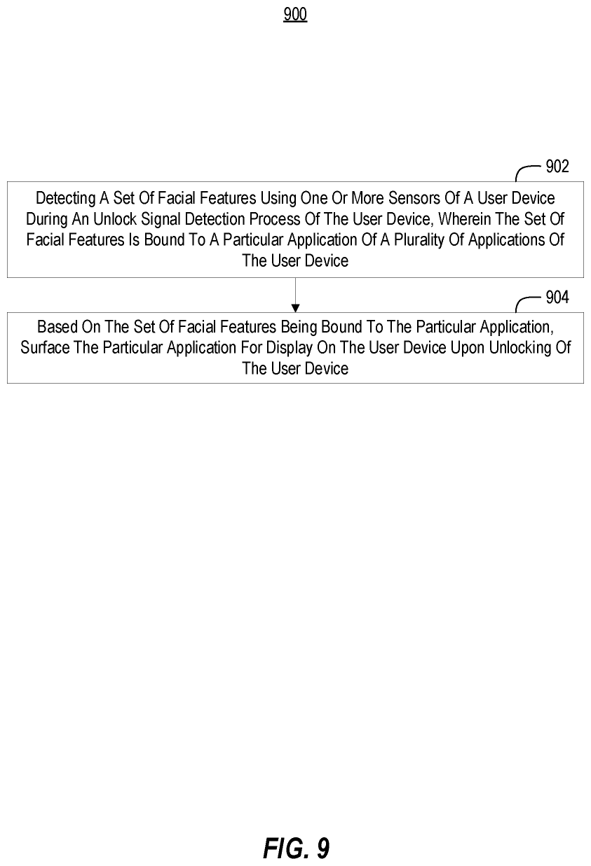

FIGS. 8 and 9 illustrate flow diagrams 800 and 900, respectively, depicting acts associated with facilitating intent-based device unlocking. The discussion of the various acts represented in the flow diagrams include references to various hardware components described in more detail with reference to FIG. 1.

Act 802 of flow diagram 800 of FIG. 8 includes detecting a set of facial features using one or more sensors of a user device. Act 802 is performed, in some instances, by a system 100 utilizing processor(s) 102, storage 104, sensor(s) 110, I/O system(s) 114, communication system(s) 116, and/or other components. In some instances, the set of facial features is extracted from a set of image frames (e.g., image(s) 208 and/or image(s) 212) detected using the one or more sensors (e.g., sensor(s) 206 of user device 204). The set of facial features may comprise a first subset of facial features (e.g., unlock facial feature(s) 210) and a second subset of facial features (e.g., intent facial feature(s) 214). In some implementations, the first subset of facial features is extracted from a first subset of images of the set of images, and the second subset of facial features is extracted from a second subset of images of the set of images.

Act 804 of flow diagram 800 includes binding the set of facial features with a particular application of a plurality of applications of the user device. Act 804 is performed, in some instances, by a system 100 utilizing processor(s) 102, storage 104, sensor(s) 110, I/O system(s) 114, communication system(s) 116, and/or other components. In some implementations, binding the set of facial features with the particular application causes the particular application to be surfaced for display on the user device upon unlocking of the user device when the set of facial features is detected during an unlock signal detection process of the user device. Unlocking of the user device may comprise transitioning the user device from a locked state to an unlocked state. In some instances, binding the set of facial features with the particular application causes the particular application, rather than a different application that was displayed on the user device when the user device entered the locked state prior to the unlocking, to be surfaced for display on the user device upon unlocking of the user device when the set of facial features is detected during the unlock signal detection process of the user device.

Act 806 of flow diagram 800 includes detecting a second set of facial features using the one or more sensors of the user device. Act 806 is performed, in some instances, by a system 100 utilizing processor(s) 102, storage 104, sensor(s) 110, I/O system(s) 114, communication system(s) 116, and/or other components.

Act 808 of flow diagram 800 includes binding the second set of facial features with a second particular application of the plurality of applications of the user device. Act 808 is performed, in some instances, by a system 100 utilizing processor(s) 102, storage 104, sensor(s) 110, I/O system(s) 114, communication system(s) 116, and/or other components. Binding the second set of facial features with the second particular application may cause the second particular application to be surfaced for display on the user device upon unlocking of the user device when the second set of facial features is detected during the unlock signal detection process of the user device. In some instances, the second set of facial features comprises the first subset of facial features (e.g., unlock facial feature(s) 210) and an additional subset of facial features (e.g., intent facial feature(s) 502 or 506).

Act 902 of flow diagram 900 of FIG. 9 includes detecting a set of facial features using one or more sensors of a user device during an unlock signal detection process of the user device, wherein the set of facial features is bound to a particular application of a plurality of applications of the user device. Act 902 is performed, in some instances, by a system 100 utilizing processor(s) 102, storage 104, sensor(s) 110, I/O system(s) 114, communication system(s) 116, and/or other components. In some implementations, detecting the set of facial features comprises capturing a set of images using the one or more sensors of the user device (e.g., user device 204). In some instances, the set of facial features comprises a first subset of facial features (e.g., unlock facial feature(s) 410) and a second subset of facial features (e.g., intent facial feature(s) 414). The first subset of facial features may be detected from a first subset of images of the set of images, and the second subset of facial features may be detected from a second subset of images of the set of images. In some instances, the set of images comprises a set of image frames of a video segment (e.g., video segment 402) captured by the one or more sensors of the user device. The second subset of images may comprise a remaining subset of image frames of the video segment that is temporally subsequent to a particular image frame of the video segment from which the first subset of facial features is detected.

Act 904 of flow diagram 900 includes based on the set of facial features being bound to the particular application, surface the particular application for display on the user device upon unlocking of the user device. Act 904 is performed, in some instances, by a system 100 utilizing processor(s) 102, storage 104, sensor(s) 110, I/O system(s) 114, communication system(s) 116, and/or other components. The unlocking of the user device may comprise transitioning the user device from a locked state to an unlocked state. In some instances, the particular application that becomes surfaced upon unlocking of the user device comprises a different application of the plurality of applications than a previous application of the plurality of applications that was displayed on the user device when the user device entered the locked state prior to the unlocking of the user device.

The acts of flow diagrams 800 and/or 900 may be performed locally on a user device and/or at least partially rely on network and/or cloud resources. For example, a server may send instructions to a user device to configure the user device to perform one or more of the acts represented in flow diagrams 800 and/or 900.

### Additional Details Related to Implementing the Disclosed Embodiments

The principles disclosed herein may be implemented in various formats. For example, the various techniques discussed herein may be performed as a method that includes various acts for achieving particular results or benefits. In some instances, the techniques discussed herein are represented in computer-executable instructions that may be stored on one or more hardware storage devices. The computer-executable instructions may be executable by one or more processors to carry out (or to configure a system to carry out) the disclosed techniques. In some embodiments, a system may be configured to send the computer-executable instructions to a remote device to configure the remote device for carrying out the disclosed techniques.

Disclosed embodiments may comprise or utilize a special purpose or general-purpose computer including computer hardware, as discussed in greater detail below. Disclosed embodiments may also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data may comprise one or more “physical computer storage media” or “hardware storage device(s),” which comprise tangible physical devices configured to store information. Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A system, comprising:
one or more processors; and
one or more hardware storage devices storing instructions that are executable by the one or more processors to configure the system to:
detect a set of facial features using one or more sensors of a user device; and
bind the set of facial features with a particular application of a plurality of applications of the user device, wherein binding the set of facial features with the particular application causes the particular application to be surfaced for display on the user device upon unlocking of the user device when the set of facial features is detected during an unlock signal detection process of the user device.

2. The system of claim 1, wherein the unlocking of the user device comprises transitioning the user device from a locked state to an unlocked state.

3. The system of claim 2, wherein binding the set of facial features with the particular application causes the particular application, rather than a different application that was displayed on the user device when the user device entered the locked state prior to the unlocking, to be surfaced for display on the user device upon unlocking of the user device when the set of facial features is detected during the unlock signal detection process of the user device.

4. The system of claim 1, wherein the set of facial features comprises a first subset of facial features and a second subset of facial features.

5. The system of claim 4, wherein the set of facial features is extracted from a set of image frames detected using the one or more sensors, and wherein the first subset of facial features is extracted from a first subset of images of the set of images, and wherein the second subset of facial features is extracted from a second subset of images of the set of images.

6. The system of claim 5, wherein the instructions are executable by the one or more processors to further configure the system to:
detect a second set of facial features using the one or more sensors of the user device; and
bind the second set of facial features with a second particular application of the plurality of applications of the user device, wherein binding the second set of facial features with the second particular application causes the second particular application to be surfaced for display on the user device upon unlocking of the user device when the second set of facial features is detected during the unlock signal detection process of the user device.

7. The system of claim 6, wherein the second set of facial features comprises the first subset of facial features and an additional subset of facial features.

8. The system of claim 1, wherein the system comprises the user device.

9. A system, comprising:
one or more processors; and
one or more hardware storage devices storing instructions that are executable by the one or more processors to configure the system to:
detect a set of facial features using one or more sensors of a user device during an unlock signal detection process of the user device, wherein the set of facial features is bound to a particular application of a plurality of applications of the user device; and
based on the set of facial features being bound to the particular application, surface the particular application for display on the user device upon unlocking of the user device.

10. The system of claim 9, wherein the unlocking of the user device comprises transitioning the user device from a locked state to an unlocked state.

11. The system of claim 10, wherein the particular application that becomes surfaced upon unlocking of the user device comprises a different application of the plurality of applications than a previous application of the plurality of applications that was displayed on the user device when the user device entered the locked state prior to the unlocking of the user device.

12. The system of claim 9, wherein detecting the set of facial features comprises capturing a set of images using the one or more sensors of the user device.

13. The system of claim 12, wherein the set of facial features comprises a first subset of facial features and a second subset of facial features, and wherein the first subset of facial features is detected from a first subset of images of the set of images, and wherein the second subset of facial features is detected from a second subset of images of the set of images.

14. The system of claim 13, wherein the set of images comprises a set of image frames of a video segment captured by the one or more sensors of the user device, and wherein the second subset of images comprises a remaining subset of image frames of the video segment that is temporally subsequent to a particular image frame of the video segment from which the first subset of facial features is detected.

15. The system of claim 9, wherein the system comprises the user device.

16. A server, the server being configured to:
store instructions to be implemented at a user device, the instructions being executable by one or more processors of the user device to configure the user device to:
detect a set of facial features using one or more sensors of a user device; and
bind the set of facial features with a particular application of a plurality of applications of the user device, wherein binding the set of facial features with the particular application causes the particular application to be surfaced for display on the user device upon unlocking of the user device when the set of facial features is detected during an unlock signal detection process of the user device; and
send the instructions to the user device.

17. The server of claim 16, wherein the unlocking of the user device comprises transitioning the user device from a locked state to an unlocked state.

18. The server of claim 17, wherein binding the set of facial features with the particular application causes the particular causes the particular application, rather than a different application that was displayed on the user device when the user device entered the locked state prior to the unlocking, to be surfaced for display on the user device upon unlocking of the user device when the set of facial features is detected during the unlock signal detection process of the user device.

19. The server of claim 16, wherein the set of facial features comprises a first subset of facial features and a second subset of facial features.

20. The server of claim 19, wherein the set of facial features is extracted from a set of image frames detected using the one or more sensors, and wherein the first subset of facial features is extracted from a first subset of images of the set of images, and wherein the second subset of facial features is extracted from a second subset of images of the set of images.
